(19) United States
(12) Patent Application Publication
(10) Pub. No.: US 2023/0331910 A1
(43) Pub. Date: Oct. 19, 2023

(54) METHOD FOR THE MANUFACTURE OF A MODIFIED POLYCARBONATE

(71) Applicant: SABIC GLOBAL TECHNOLOGIES B.V., Bergen op Zoom (NL)

(72) Inventors: Robert Russell Gallucci, Mount Vernon, IN (US); Sripradha Suresh, Plano, TX (US); Mehdi Mahmoodi, Newburgh, IN (US)

(21) Appl. No.: 17/766,309

(22) PCT Filed: Sep. 24, 2020
(86) PCT No.: PCT/EP2020/076784

§ 371 Date: Apr. 4, 2022

(30) Foreign Application Priority Data
Oct. 7, 2019 (EP) 19201607.9

(51) Int. Cl. C08G 64/42; C08G 64/06; C08G 64/24; C08G 64/30; C08K 5/20; B29C 48/00; B29B 7/00

(52) U.S. Cl. CPC C08G 64/42; C08G 64/06; C08G 64/24; C08G 64/307; C08K 5/20; B29C 48/022; B29B 7/007; B29C 2948/92704; B29C 2948/92561; B29K 2069/00

(57) ABSTRACT

The present invention relates to a method for the manufacture of a modified polycarbonate comprising reacting polycarbonate with at least one primary amide in a melt mixing device at a temperature of at least 230° C. for a period of at least 0.5 minutes.

The present invention relates to a method for the manufacture of a modified polycarbonate.

Polycarbonate is a well-known material in all kinds of applications and a typical method for manufacturing products from polycarbonate resin is by means of injection moulding. As is known injection moulding involves injecting a molten stream of resin material into a mould, followed by cooling the resin. Once the resin has sufficiently cooled the mould can be opened and the product can be taken out. A disadvantage of polycarbonate is that it tends to stick to the surface of the mould so that a certain amount of force is needed to take the injection moulded product out of the mould.

In order to mitigate this problem it is commonly known to use mould release agents such as for example penta-erythritol tetrastearate (PETS), glycerol mono-stearate (GMS) or glycerol tristearate (GTS).

US 2013/0216801 discloses a thermoplastic composition comprising a polycarbonate and having a melt flow index as defined by ASTM D1238 of 10 g/10 min. to 50 g/10 min. at 300° C. and a 1.2 kg load, the thermoplastic composition including a polycarbonate, the thermoplastic composition comprising 20 mol % to 80 mol % of specified cyclohexylidene-bridged carbonate units and 80 mol % to 20 mol % of specified other carbonate units. The substrate has a hard coat thereon that provides the article with a pencil hardness of at least 5H as determined according to JIS K5400 using a 0.75 kgf load. This document discloses certain flow promotors that can be used together with the polycarbonate disclosed therein, which include erucamide. This reference does not teach or suggest that under certain conditions erucamide (or any other primary amide) can be used to modify, i.e. react with, the polycarbonate providing the same with specific advantageous properties.

Another disadvantage of polycarbonate is that upon higher molecular weight, which is favourable for good impact properties, the melt is rather viscous. In order to mitigate this high viscosity the polycarbonate can be processed at higher temperature, which may in turn lead to deterioration of the resin possibly resulting in a reduction of the color properties.

It is therefore an object of the invention to provide for a polycarbonate having, in combination, good flow, impact and mould-release properties.

To that extent the present invention relates to a method for the manufacture of a modified polycarbonate comprising reacting polycarbonate with at least one primary amide in a melt mixing device at a temperature of at least 230° C. for a period of at least 0.5 minutes.

More in particular, the present invention relates to a method for the manufacture of a modified polycarbonate comprising reacting polycarbonate with at least one primary amide in a melt mixing device at a temperature of at least 230° C. for a period of at least 0.5 minutes, wherein the modified polycarbonate has a melt volume rate determined according to ASTM D1238 (300° C., 1.2 kg) which is at least 10% higher than the melt volume rate of the polycarbonate.

It was surprisingly found that the polycarbonate obtained with the method as disclosed herein showed, compared to same polycarbonate not being modified, an increased melt flow in combination with improved mould release properties and acceptable toughness.

Accordingly, under application of the present invention the aforementioned object is met, at least in part.

Polycarbonate

The method disclosed herein is in principle not limited to a specific type of polycarbonate. Accordingly the polycarbonate may be a homopolymer or a (block) copolymer or a mixture of one or more homopolymers, one or more copolymers, or one or more of a copolymer and a homopolymer. It is preferred however that the polycarbonate is an aromatic polycarbonate homopolymer, more preferably an aromatic bisphenol A polycarbonate.

Preferably such polycarbonate is obtained by reacting a bisphenol, such as bisphenol A, with a carbonate source such as phosgene or a diarylcarbonate such as diphenyl carbonate. Accordingly the polycarbonate may be prepared using the so called interfacial process, wherein BPA reacts with phosgene, or may be prepared by means of the so-called melt or direct transesterification process, wherein BPA reacts with diphenyl carbonate in molten state. These two types of polycarbonate are known to the skilled person and may be further referred to herein as interfacial polycarbonate and melt polycarbonate. The skilled person knows that these two types of polycarbonate differ in amount of Fries branching, which only exists in melt polycarbonate and terminal hydroxyl content, which is typically much lower for interfacial polycarbonate.

It is preferred that the polycarbonate is obtained via the interfacial process for the reason that said process, compared to the melt process, typically provides polycarbonate with a low number of hydroxyl chain ends. A low amount of hydroxyl chain ends is advantageous for heat stability and color retention of the polycarbonate. Nonetheless, polycarbonate obtained via the melt process, i.e. melt polycarbonate, is not excluded from being used in the present invention. In an embodiment the polycarbonate is a mixture of at least one polycarbonate obtained via the interfacial process and at least one polycarbonate obtained with the melt process.

The polycarbonate is preferably end capped with a mono phenol selected from the group consisting of phenol, t-butyl phenol, p-cumyl phenol, C1 to C16 alkyl substituted phenols or any mixture thereof. P-cumyl phenol being a preferred end capping agent.

The polycarbonate preferably has a weight average molecular weight of from 15,000-60,000 Daltons as determined with GPC using polycarbonate standards. In case the polycarbonate is a mixture of polycarbonates then each of these polycarbonates has a weight average molecular weight in this range. The polycarbonate has a glass transition temperature (Tg), as determined using DSC, of from 130-220° C. Bisphenol A type of polycarbonate typically has a Tg of about 147° C.

The polycarbonate, or mixture of polycarbonates, preferably has a melt volume rate (MVR) of from 3 to 35 cm³/10 min as determined in accordance with ISO 1133 (300° C., 1.2 kg). Preferably the MVR is from 6 to 25, more preferably from 14-21 cm³/10 min. For the avoidance of doubt it is noted that this refers to the MVR of the polycarbonate before the modification as disclosed herein.

In the context of the invention it is preferred that at least part of the polycarbonate is post-consumer recycled polycarbonate (PCR-PC). Thus it is preferred that the polycarbonate contains at least 2, preferably at least 5, more preferably at least 10 wt. % of PCR-PC. In case of such blends of PCR-PC and virgin polycarbonate the blend may contain from 10-90 wt. % of PCR-PC, such as from 20-80 wt. % or from 40-60 wt. %, based on the weight of the blend. In an embodiment the blend may contain at most 20 wt. % PCR-PC such as from 1-15 wt. %.

Primary Amide

The amide used to modify the polycarbonate in the method of the present invention is a primary amide. To that extent the present inventors have found that secondary or tertiary amides do not, or to a much lesser extent, provide the technical effect of improved flow and mould release properties. The primary amide is preferably of general structure R—CO—NH2 wherein R is an organic group. The group R may be a linear or branched group and may or may not contain hetero-atoms. Typical hetero-atoms include oxygen, sulphur, phosphorous and nitrogen. Preferably R is an aliphatic group, having from 10-50 carbon atoms. Group R may contain unsaturations, i.e. double bonds between neighbouring carbon atoms, but it is preferred that the group R is a saturated organic group, preferably a saturated branched or linear aliphatic group. Thus, it is preferred that primary amide is an alkyl amide with less than 100 ppm (mol), more preferably less than 10, most preferably less than 1 ppm carbon-carbon double bond unsaturation.

Typical examples of primary amides to be used in the present invention are butyramide, caproamide, caprylamide, catramide, lauramide, myristamide, plamitamide, stearamide, arachidamide, behenamide ignoceramide, cerotamide, montanamide, melissamide, iso-decamide, iso-octadecanamide, palmitoleamide, oleamide, vaccenamide, erucamide, linolenamide, linolamide, gadoleamide, gondoamide and the like and any mixtures thereof.

It is preferred that the primary amide is selected from the group consisting of C10-C50 linear carboxylamides. If the amide has a too high molecular weight then the presence of the amide may cause haze in the composition.

Amides with a boiling point above 200° C. or even 300° C. may be preferred.

Most preferably the amide is selected from the group consisting of iso-octadecanamide, erucamide, behenamide and mixtures of at least two of the foregoing primary amides.

Modified Polycarbonate

The present invention also relates to the modified polycarbonate obtained or obtainable by the method disclosed herein. Although the present inventors have found that the amide reacts with the polycarbonate, the exact structure after the modification is not known in detail. However in addition to improving melt flow and mold release properties, the process results in an increase of polarity with higher para-hydroxy phenol group generation, with little or no change in ortho-hydroxy phenolic end group content generating a chemically modified polymeric substance. The process produces a modified polycarbonate comprising both ortho and para hydroxy phenolic end groups wherein the para phenolic end groups predominate and the total of phenolic end groups is greater than 80 ppm, and in other instances greater than 100 ppm.

The modified polycarbonate preferably has a weight average molecular weight of from 15,000-60,000 Daltons as determined with GPC using polycarbonate standards.

The present inventors have found that the modified polycarbonate may have a melt volume rate determined according to ASTM D1238 (300° C., 1.2 kg) which is at least 10% higher than the melt volume rate of the polycarbonate can be obtained.

The present inventors further found that the modified polycarbonate shows less than a 25% change in melt viscosity after heating for an additional 30 minutes at 300° C.

The modified polycarbonate preferably has phenolic end groups comprising both ortho-para and p,p-bisphenol A and wherein the para-para BPA phenolic end groups predominate and the total of phenolic end groups is greater than 100 ppm.

The modified polycarbonate preferably has one or more of:
a transmission of at least 80%,
a haze of at most 5.0%,
a yellowness index of at most 20
a notched Izod impact of at least 400 J/m,
   wherein the transmission haze and yellowness index are determined on a 3.2 mm injection moulded plaque. For the avoidance of doubt it is noted that these properties are determined on as produced moulded plaques, i.e. prior to any aging.

The transmission is preferably at least 85%, more preferably at least 86%. The haze is preferably at most 2.0%, more preferably at most 1.0%.

The yellowness index is preferably at most 10, preferably at most 5.0, more preferably at most 2.0.

The notched Izod impact is preferably from 400-800 J/m or from 400-700 J/m.

It is preferred that the modified polycarbonate has one or more, preferably all of:
a transmission of at least 87%,
a haze of at most 2.0%,
a yellowness index of at most 5, preferably at most 3
a notched Izod impact of from 400-800 J/m
   wherein the transmission haze and yellowness index are determined on a 3.2 mm injection moulded plaque. Again, and for the avoidance of doubt it is noted that these properties are determined on as produced moulded plaques, i.e. prior to any aging.

Accordingly the present invention relates to a method for the manufacture of a modified polycarbonate having one or more, preferably all, of a transmission of at least 80%, a haze of at most 5%, a yellowness index of at most 20 and a notched Izod impact of at least 400 J/m.

Accordingly and preferably the present invention relates to a method for the manufacture of a modified polycarbonate having one or more, preferably all, of
a transmission of at least 87%,
a haze of at most 2.0%,
a yellowness index of at most 5, preferably at most 3
a notched Izod impact of from 400-800 J/m
   wherein the transmission haze and yellowness index are determined on a 3.2 mm injection moulded plaque. Again, and for the avoidance of doubt it is noted that these properties are determined on as produced moulded plaques, i.e. prior to any aging.

The notched Izod impact is determined at 23° C. on injection moulded bars of dimensions 64×13×3.2 mm in accordance with ASTM D256-10.

The present invention further relates to a composition comprising the modified polycarbonate disclosed herein, i.e. obtained or obtainable by the method disclosed herein.

Such a composition may contain, in addition to the modified polycarbonate, one or more additives common in the art such as anti-oxidants, UV stabilisers, infrared blocking materials, fillers, reinforcement agents, impact modifiers, flame retardants, anti-drip agents, heat stabilisers, colorants.

Preferably a phosphite, phosphinate or mixture thereof is used as a stabiliser during the melt modification process as disclosed herein. Typically the amount of such stabilisers is from 0.01 to 1.0 wt. %. .%. Preferred phosphorus containing stabiliser is a phosphonite wherein one of the P bonds is attached directly to an aryl radical. Examples of such compounds are presented in U.S. Pat. No. 4,075,163. Difunctional phosphorus containing compounds can also be employed. Preferred phosphite or phosphinate stabilisers are selected from the list consisting of alkyl substituted tri aryl phosphites, tetrakis(2,4-di-tert-butylphenyl)4,4′-biphenylene diphosphonite, tris(2,4-di-tert-butylphenyl)phosphite, tris(nonylphenyl)phosphite, Bis (2,4-dicumylphenyl) pentaerythritol diphosphite, Bis (2,4-di-tbutylphenyl) pentaerythritol diphosphite, Bis (2,6-di-tbutylphenyl-4-methyl pentaerythritol) diphosphite, triphenyl phosphite, tricresyl phosphite or any mixtures thereof. Stabilisers may have a molecular weight greater than or equal to 300 g/mol. In some embodiments, phosphorus containing stabilizers with a molecular weight greater than or equal to 500 g/mol are useful.

The Method Modification of the polycarbonate so as to form the modified polycarbonate is carried out in the melt at a temperature of at least 230° C. and for a time sufficient to allow the primary amide to react with the polycarbonate, which is found to be 0.5 minutes at least. The temperature may be from 250-350° C., preferably from 270-320° C. for a period of at least 0.5 minutes, such as from 0.5-15 minutes, 0.5-10 minutes, 0.5-5 minutes. The reaction time may be from 1-15, 1-10, 2-15, 2-10 minutes. The optimum conditions depend inter alia on the type of amide, the MVR of the polycarbonate and the temperature of modification. The modification of the polycarbonate can be confirmed by measurement of the viscosity, e.g. in the form of the melt volume rate, of the modified polycarbonate. A modified polycarbonate has a higher melt volume rate compared to the polycarbonate prior to modification.

The amount of amide to be used during the modification is from 0.05 to 5.0 wt. % on the basis of the weight of the polycarbonate to be modified. Preferably the amount is from 0.1 to 1.0 wt. %.

The polycarbonate to be modified in solid form may be pre-mixed with the primary amide followed be feeding the so obtained mixture to the melt mixing device, in particular an extruder. Alternatively the polycarbonate to be modified may be fed in solid form, such as e.g. in the form of pellets or powder, to a feed section of an extruder and the primary amide is fed to the same extruder at a location downstream of the said feed section. In yet a further alternative the polycarbonate is fed to an extruder in molten form and the primary amide is fed to the extruder together or at a location downstream of a feed section of the extruder. This particular embodiment is preferred in particular for polycarbonate obtained via the melt process wherein a molten stream from a final polycondensation reactor is fed directly into an extruder. By treatment with the primary amine “in-line” an additional heat cycle of the polycarbonate is avoided which is beneficial for product quality, in particular color properties.

For the avoidance of doubt it is noted that the method disclosed herein does not include the use of a solvent, i.e. the method is a solvent-free method.

The method may be carried out in polymer melt-mixing devices known in the art per se including internal mixers such as Banbury mixers, single screw extruders, co-rotating twin screw extruders and counter-rotating twin screw extruders.

Preferably the method is carried out in an extruder, such as a co-rotating twin screw extruder. The use of an extruder allows the modification to be carried out continuously thereby providing a polycarbonate with a stable level of modification.

Preferably the method involves the use of a twin screw extruder operating at 250 to 380° C. with a screw speed of 200 to 1000 rpm. The application of atmospheric pressure is preferred. Application of vacuum venting may carry off additives and/or reactants.

Following the modification in the extruder the modified polycarbonate is preferably extruded through a die into at least one strand followed by cooling the at least one strand into pellets. The pellets in turn can be used for the injection moulding, extrusion moulding or low moulding of articles.

Alternatively, the obtained modified polycarbonate can be used for the manufacture of compounds or blends, such as for example polycarbonate—acrylonitrile-butadiene-styrene copolymer blends (PC/ABS) or polycarbonate—polyester blends such as blends of polycarbonate with one or more of polyethylene terephthalate, polybutylene terephthalate and polycyclohexylenedimethylene terephthalate. In turn these blends can be used for the manufacture of injection moulded articles.

The present invention relates to an article comprising the modified polycarbonate as disclosed herein. Preferably such an article is an injection moulded article. In an embodiment the article comprises a wall thickness of from 1.0 to 10.0 mm.

The present invention further relates to the use of primary amides of general structure R—CO—NH2 wherein R is an organic group, preferably an aliphatic group, having from 10-50 carbon atoms, for modifying polycarbonate in a melt mixing device at a temperature of at least 230° C. for a period of at least 0.5 minutes, for increasing the melt volume rate of said polycarbonate.

The modified polycarbonate preferably has a phenolic end group content of at least 50 ppm. Preferably the phenolic end groups content is from 80 to 200 ppm.

The present invention will now be further elucidated on the basis of the following non-limiting examples.

All examples were prepared and tested in a similar manner as discussed below. The ingredients of the examples shown below were tumble blended in a paint shaker and then extruded on a 30 mm Werner Pfleiderer co-rotating twin screw extruder with an atmospheric vented mixing screw, at a barrel and die head temperature between 250 and 300° C. and at a screw speed of 400 rpm. The melt was extruded as a strand which was cooled through a water bath prior to being cut into pellets.

Test specimens were prepared on the basis of pellets that were dried at 125° C. for at least 2 hr.

Molded part testing was done on 3.2 mm ASTM parts equilibrated at 50% RH for at least 2 days.

Notched Izod was measured as per ASTM D256-10.

Yellowness Index (YI), percent transmission (% T) and percent haze (% H) were measured on 3.2 mm injection moulded plaques as per ASTM D1003-03 as molded, i.e. without aging, and after aging in air for 7 days at 130° C.

Tg was measured as per ASTM D3418-03 at a 20° C./min heating rate.

Molecular weights were determined using gel permeation chromatography (GPC) as per ASTM D5296-05, polycarbonate (PC) used PC standards, PBT Mw used polystyrene standards.

Melt viscosity was measured by melt volume rate (MVR) expressed in cc/10 min in accordance with ASTM D1238-13, measured at a temperature of 300° C. and a weight of 1.2 kg and after a 6 minute or 18 minute equilibration.

Viscosity versus time, also known as melt dwell or time sweep, was run using a parallel plate/cone-plate fixture rheometer at 300° C. for 30 minutes at a rate of 10 radians/second under nitrogen atmosphere and according to ASTM D4440-15. Viscosity at the onset (after a 6 minute equilibration) and at the end of the test (30 minutes after equilibration) was compared to show the relative stability of the molten polymers.

Phenolic end group content was determined by NMR. Hydroxyl end group content can be determined according to the method as disclosed for example in U.S. Pat. No. 9,040,651 (column 13, lines 40-57). In that method, 225 milligrams of polymer were combined with 4 milliliters of 0.5 M chromium acetylacetonate in chloroform having a known concentration of internal standard. Once the polymer was dissolved, the resulting solution was treated with an excess of 1,2-phenylene phosphorochloridite and transferred immediately to a 5 or 10 millimeter diameter nuclear magnetic resonance (NMR) sample tube, and 31P NMR shifts were recorded with a pulse width of 35°, 32,000 or 64,000 data points per scan, a 1.8 second delay, and 1600-2500 scans. The parts per million by weight of hydroxyl end groups (ppm OH) was calculated according to the equation:

ppm OH=(weight of standard/molecular weight of standard)×(integral OH/integral standard)×17.01×(1/weight of polymer)×(4 mL/100 mL)×106.

A similar method of determining the hydroxyl end group content of an aromatic polymer is described in K. P. Chan, D. S. Argyropoulos, D. M. White, G. W. Yeager, and A. S. Hay, “Facile Quantitative Analysis of Hydroxyl End Groups of Poly(2,6-dimethyl-1,4-phenylene oxide)s by 31P NMR Spectroscopy,” Macromolecules, 1994, volume 27, pages 6371-6375. The p-BPA phenolic (OH) end group signal is at 125.2 ppm, the o-BPA OH signal is at 130.8 ppm.

The materials used in the examples are shown in Table 1.

TABLE 1

| Material | Description |
|---|---|
| PC | Bisphenol A polycarbonate obtained via the interfacial |
| | process having a Mw of 21,000 (PC standards), a MVR |
| | of 27 cc/10 min and endcapped with para-cumyl phenol. |
| PETS | Penta erythritol tetra stearate |
| EBS | Ethylene bis stearamide |
| Am_1 | Iso stearyl amide (Iso-octadecanamide), saturated |
| | branched alkyl amide |
| Am_2 | Behenamide, saturated linear alkyl amide |
| Am_3 | Erucamide, unsaturated alkyl amide |
| Stabiliser | Tris (2,4 di-tert butyl phenyl) phosphite |

Amides 1, 2 and 3 are primary amides.

Based on these materials the compositions as detailed in Table 2 were prepared. Materials are indicated in weight parts, with each composition totaling to 100 wt. %

TABLE 2

| Ex. | Ref | CE1 | CE2 | CE3 | E1 | E2 | E3 | E4 |
|---|---|---|---|---|---|---|---|---|
| PC | 99.92 | 99.62 | 99.82 | 99.62 | 99.82 | 99.62 | 99.62 | 99.62 |
| PETS | | 0.30 | | | | | | |
| EBS | | | 0.10 | 0.30 | | | | |
| Am_1 | | | | | 0.10 | 0.30 | | |
| Am_2 | | | | | | | 0.30 | |
| Am_3 | | | | | | | | 0.30 |
| Stab. | 0.08 | 0.08 | 0.08 | 0.08 | 0.08 | 0.08 | 0.08 | 0.08 |
| Tg [° C.] | 148.6 | 145.8 | 149.1 | 147.1 | 146.4 | 144.1 | 144.6 | 144.3 |
| Mw_pellet | 21520 | 21536 | 21497 | 21351 | 21189 | 20618 | 20870 | 20731 |
| Mn_pellet | 9402 | 9476 | 9394 | 9160 | 9300 | 9106 | 9321 | 9328 |
| Mw_part | 21892 | 21791 | 21543 | 21459 | 20941 | 19469 | 19468 | 19616 |
| Mn_part | 9470 | 9439 | 9352 | 9272 | 9098 | 8426 | 7358 | 8640 |
| Mw drop | 0 | 0 | 0 | 0 | 1 | 6 | 7 | 5 |
| MVR_6 | 27.1 | 29.7 | 31.7 | 31.9 | 37.5 | 56.7 | 44.1 | 51.8 |
| MVR_18 | 29.9 | 29.2 | 33.8 | 38.4 | 40.7 | 62.5 | 54.9 | 59.9 |
| ΔMVR | 6.6 | −1.7% | 6.6 | 20.4 | 8.5 | 10.2 | 24.5 | 15.6 |
| NI | 727 | 727 | 733 | 705 | 710 | 652 | 650 | 430 |

Optical properties before aging

| | | | | | | | | |
|---|---|---|---|---|---|---|---|---|
| T % | 89.2 | 89.5 | 89.5 | 89.5 | 89.5 | 89.5 | 89.2 | 89.0 |
| Haze | 1.2 | 0.6 | 0.6 | 0.6 | 0.6 | 0.6 | 0.8 | 1.1 |
| YI | 21. | 1.6 | 1.8 | 1.8 | 1.8 | 1.9 | 2.7 | 4.1 |

Optical properties after aging 7 days at 130° C.

| | | | | | | | | |
|---|---|---|---|---|---|---|---|---|
| T % | 89.2 | 89.3 | 89.4 | 89.4 | 87.1 | 89.0 | 89.2 | 87.9 |
| Haze | 1.4 | 0.8 | 0.6 | 0.5 | 0.6 | 0.6 | 0.4 | 1.3 |
| YI | 1.8 | 2.2 | 2.7 | 2.9 | 2.9 | 3.9 | 3.4 | 7.3 |

In Table 2:
Mw_pellet represents the weight average molecular weight of the material in pellet form prior to being moulded into a part.
Mw_part represents the weight average molecular weight of the material after moulding the pellets into a moulded part.
Mw_drop represents the percentage in reduction of the molecular weight resulting from the modification and/or moulding of the material.
MVR_6 represents the melt volume rate after a equilibration time of 6 minutes.
MVR_18 represents the melt volume rate after a equilibration time of 18 minutes.
ΔMVR represents the difference (in percent) of the MVR_18 versus the MVR_6.
NI represents the Notched Impact strength at 23° C. in J/m.

The examples in Table 2 shows a remarkable improvement in MVR for the polycarbonates that were modified with the primary amides. At the same time the optical properties as well as impact performance was maintained at an acceptable level. The molecular weight is largely maintained for all samples.

As seen in Table 3 the chemically modified polycarbonates of Examples 1-4 show an increase in phenol end groups over the PC control (Ref) or PC with PETS (CE1) and secondary amide (CE2 and CE3). It was found that the polycarbonate has both ortho and para-phenol end groups. The chemical modification of the method of the invention produces over 100 ppm of para phenolic chain ends with little, if any, change in ortho phenolic content.

TABLE 3

| Ex. | Ref | CE1 | CE2 | CE3 | E1 | E2 | E3 | E4 |
|---|---|---|---|---|---|---|---|---|
| PPM | 69 | 71 | 79 | 78 | 117 | 167 | 103 | 113 |
| p-BPA-OH | | | | | | | | |
| PPM | 74 | 83 | 74 | 76 | 68 | 75 | 81 | 84 |
| o-BPA-OH | | | | | | | | |

This data shows that the polycarbonate is actually modified by the method of the invention.

Table 4 shows the melt stability of the examples where the polycarbonates modified with primary amides showed a retention of their initial viscosity of at least 80%. The left column shows the time in seconds while the data represents the viscosity measured as described above at a temperature of 300° C.

TABLE 4

| | Ex. | | | | | | | |
|---|---|---|---|---|---|---|---|---|
| Time [s] | Ref | CE1 | CE2 | CE3 | E1 | E2 | E3 | E4 |
| 100 | 191 | 178 | 172 | 157 | 161 | 86 | 92 | 98 |
| 200 | 191 | 177 | 171 | 153 | 158 | 84 | 90 | 96 |
| 400 | 190 | 176 | 168 | 148 | 156 | 80 | 86 | 94 |
| 600 | 189 | 176 | 167 | 144 | 154 | 77 | 83 | 92 |
| 800 | 188 | 175 | 167 | 140 | 152 | 75 | 81 | 91 |
| 1000 | 188 | 175 | 165 | 138 | 152 | 75 | 80 | 90 |
| 1200 | 187 | 175 | 162 | 136 | 151 | 74 | 79 | 89 |
| 1400 | 187 | 175 | 161 | 135 | 150 | 74 | 79 | 89 |
| 1600 | 187 | 174 | 158 | 134 | 150 | 74 | 78 | 89 |
| 1800 | 187 | 174 | 156 | 132 | 150 | 74 | 78 | 89 |
| Retention of | 98 | 98 | 91 | 84 | 93 | 86 | 85 | 91 |
| initial viscosity | | | | | | | | |
| [%] | | | | | | | | |

Further experiments with the primary amide AM_2 (behenamide) were done using varying concentrations of the amide. Process settings were the same as for the Examples 1-4 and CE1-CE3 above.

Table 5 shows the results of these additional experiments.

TABLE 5

| Ex. | Ref | E5 | E6 | E7 | E8 |
|---|---|---|---|---|---|
| PC | 99.92 | | | | |
| Am_2 | | 0.05 | 0.10 | 0.15 | 0.30 |
| Stab. | 0.08 | 0.08 | 0.08 | 0.08 | 0.08 |
| Mw_pellet | 21520 | 21550 | 21440 | 21443 | 21419 |
| Mn_pellet | 9402 | 9781 | 9759 | 9715 | 9656 |
| MVR_6 | 27.1 | 31.5 | 33.1 | 37 | 44.6 |

From the Table 5 it can be concluded that already relatively low amounts of primary amide result in an improved melt volume rate.

Mold Release Properties

The primary amide modified PC resins of Examples 2, 3 and 4 were injection molded on a cup tool that allowed measurement of the ejection force needed to de-bond the polycarbonate parts from the steel tool. Lower pressures that allow for facile part removal are preferred. The state of the art comparative technology uses non-reactive mold release agents to overcome the inherent stickiness of the PC resin. Such non-reactive release agents are typically alkyl esters such as PETS (Comparative Example 1).

The cup tool is a mould for the moulding of a part in the shape of a cylindrical cup having a wall thickness of 3 mm.

Cups were moulded using the cup tool from materials that were dried 4 hours at 125° C. In the injection moulding equipment the screw temperature was between 270 and 300° C. and the cycle time was 35 seconds with an injection speed of 1.2 inch (3.05 cm) per second, an injection pressure of 750 psi (51.7 bar), a hold pressure of 500 psi (34.5 bar), a mould temperature of 85° C. and a 0.24 inch (0.61 cm). The ejection pressure values are measured with a pressure sensor as psi and are the average of 20 shots after discarding the first five shot values.

TABLE 6

| | Ejection force [psi] |
|---|---|
| CE1 | 360 |
| CE3 | 340 |
| E2 | 250 |
| E3 | 230 |
| E4 | 280 |

Table 6 shows the release pressure is significantly reduced for polycarbonate modified with primary amides. The secondary amide EBS (CE3) shows almost no improvement compared to CE1 which is based on the commonly used PETS mould release agent.

1. A method for the manufacture of a modified polycarbonate comprising reacting polycarbonate with at least one primary amide in a melt mixing device at a temperature of at least 230° C. for a period of at least 0.5 minutes, wherein the modified polycarbonate has a melt volume rate determined according to ASTM D1238 (300° C., 1.2 kg) which is at least 10% higher than the melt volume rate of the polycarbonate.

2. The method of claim 1, wherein the modified polycarbonate has one or more, preferably all of a transmission of at least 87%, a haze of at most 2%, a Yellowness Index of at most 5 and a notched Izod Impact of at least 400 J/m measured on plaques as moulded and in accordance with the methods specified in the description.

3. The method of claim 1, wherein the polycarbonate is a bisphenol A polycarbonate obtained from an interfacial process comprising reacting bisphenol A with phosgene, or from a direct transesterification process comprising reacting bisphenol A with diphenyl carbonate in molten state.

4. The method of claim 1 wherein the modified polycarbonate has a weight average molecular weight of from 15,000-60,000 Daltons as determined with GPC using polycarbonate standards.

5. The method of claim 1 wherein the primary amide is of general structure R—CO—NH₂ wherein R is an organic group.

6. The method of claim 5 wherein R is an aliphatic group.

7. The method of claim 1 wherein the primary amide is selected from the group consisting of butyramide, caproamide, caprylamide, catramide, lauramide, myristamide, plamitamide, stearamide, arachidamide, behenamide ignoceramide, cerotamide, montanamide, melissamide, iso-decamide, iso-octadecanamide, palmitoleamide, oleamide, vaccenamide, erucamide, linolenamide, linolamide, gadoleamide, gondoamide and mixtures of two or more of the foregoing primary amides.

8. The method of claim 1 wherein the polycarbonate comprises or consists of post-consumer recycled polycarbonate.

9. The method of claim 1 wherein the method is a continuous method.

10. The method of claim 1 further comprising extruding the modified polycarbonate through a die into at least one strand, followed by cooling the at least one strand into pellets.

11. A modified polycarbonate obtained or obtainable by the method of claim 1.

12. A composition comprising the modified polycarbonate of claim 11.

13. An article comprising the modified polycarbonate of claim 11.

14. The article of claim 13, wherein the article is an injection moulded article.

15. The method of claim 1, wherein the primary amide is of general structure R—CO—NH₂ wherein R is an aliphatic group, having from 10-50 carbon atoms.
